(19) United States
(12) Patent Application Publication
(10) Pub. No.: US 2009/0282289 A1
(43) Pub. Date: Nov. 12, 2009

(54) GENERATION AND EVALUATION OF TEST CASES FOR SOFTWARE VALIDATION AND PROOFS

(75) Inventors: Aditya V. Nori, Bangalore (IN); Sriram K. Rajamani, Bangalore (IN); Robert J. Simmons, Pittsburgh, PA (US); Nels Beckman, Pittsburgh, PA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/115,633

(22) Filed: May 6, 2008

(51) Int. Cl. G06F 11/36

(52) U.S. Cl. 714/38; 714/E11.211

(57) ABSTRACT

A “property checker” uses light-weight symbolic execution to prove that software programs satisfy safety properties by simultaneously performing program testing and program abstraction. A simple example of safety properties includes conditions that must be satisfied for proper program execution, such as whether an application properly interfaces with API methods or functions. Program tests are an “under-approximation” of program behavior, and abstractions are an “over-approximation” of the program. This simultaneous testing either finds a test-case that reaches an error state, or finds an abstraction showing that no path in the state space of the program can reach any error state. If a test-case reaches an error state, the property checker has discovered a violation of the safety property. Conversely, if no path in the state space can reach any error state, the property checker has proved that the program satisfies the desired safety property.

### BACKGROUND

1. Technical Field

A “property checker” provides various techniques for efficiently computing proofs of correctness and incorrectness (bugs) of software programs, and in particular, various techniques for determining whether a software program satisfies required properties, such as, for example, whether an application uses an API correctly, and for automatically generating test cases that witness violations of required properties.

2. Related Art

Conventionally, the use of light-weight symbolic execution, implemented through program instrumentation, has been used to do automatic test-case generation for testing software programs for the presence of errors or “bugs.” For example, one conventional testing technique generally operates by iteratively refining tests and abstractions, using the abstractions to guide generation of new tests, and using the tests to guide where to refine the abstraction. While it is useful to use tests to guide where abstractions need to be refined, it is generally computationally expensive to maintain and refine abstractions, since it typically requires a large number of theorem prover calls to maintain abstractions. Furthermore, to maintain abstractions for programs with pointers, a separate may-alias analysis is required to conservatively update the abstraction due to pointer aliases.

Several conventional software tools, based on predicate abstraction and counterexample-guided abstraction refinement, have been created in order to compute proofs of program properties. The algorithms implemented in these tools generally entail several expensive calls to a theorem prover that can adversely impact performance and scalability of these tools. There has also been significant progress in software testing techniques that use light-weight symbolic execution. These testing tools focus on finding errors in programs by way of explicit path model checking and are unable to compute proofs.

Further, a number of conventional techniques have proposed that software testing and verification can be combined. For example, one such technique provides an approach that involves both abstraction and software testing. This approach examines abstract counterexamples and fabricates new concrete states along those counterexamples as a heuristic to increase the coverage of testing. Further, this approach also detects when the current program abstraction is a proof. However, this technique fails to provide any abstraction refinement mechanisms. A related approach provides a technique to perform abstraction refinement using concrete program execution. This refinement approach is based on partial program simulation using Boolean satisfiability problem (SAT) solvers.

Another technique combines testing and abstraction refinement based verification algorithms by using tests to decide where to refine the abstraction, and to make theorem prover calls to maintain the abstraction. Unfortunately, this technique is not capable of fully handling programs with pointers and procedures. Some conventional verification tools employ a path-sensitive inter-procedural dataflow engine to analyze programs with multiple procedures. This generally involves computing abstract summaries for every procedure in the program. Recently, inter-procedural extensions to testing tools have been proposed for computing concrete summaries for every procedure in the program.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In general, a “property checker,” as described herein, provides a modular inter-procedural analysis algorithm that combines software program testing and abstraction to perform automated analysis of software. In other words, the property checker uses light-weight symbolic execution to prove that software programs satisfy safety properties by simultaneously performing program testing and program abstraction. Intuitively, the property checker analyzes called functions and/or procedures using path-sensitive information from the caller. The result of this analysis is then fed back to the caller in the form of both concrete as well as abstract summaries. In related embodiments, the property checker efficiently computes proofs for use by other software testing programs.

Further, the property checker uses automatically generated test-cases (also referred to herein as “tests”) to choose a “frontier” of abstract counterexamples, and tries to either extend or refine the frontier with exactly one theorem prover call. The property checker also uses tests to decide where to refine the abstraction, and more importantly, uses this information to decide what refinement to apply, thus maintaining the abstraction without any extra theorem prover calls. The property checker also handles programs with pointers without using any whole-program may-alias analysis, and performs an inter-procedural analysis by way of recursive invocations to itself.

More specifically, the property checker provides various techniques that use only test-case generation operations to construct proofs of whether programs obey safety properties. For example, a safety property may include a particular property that must be satisfied for proper program execution, such as, for example, whether an application properly interfaces with a conventional library function. If the program does not obey a particular property, the property checker generates a test-case that witnesses the violation of that property. From a practical viewpoint, the property checker handles a full programming language with procedure calls and pointers. From a conceptual viewpoint, the property checker provides a novel refinement technique that uses no extra theorem prover calls and no global may-alias information to validate correctness or to prove incorrectness of software programs.

In view of the above summary, it is clear that the property checker described herein provides various unique techniques for performing automated analysis of software by using light-weight symbolic execution to prove that software programs satisfy safety properties by simultaneously performing program testing and program abstraction. In addition to the just described benefits, other advantages of the property checker will become apparent from the detailed description that follows hereinafter when taken in conjunction with the accompanying drawing figures.

### DESCRIPTION OF THE DRAWINGS

The specific features, aspects, and advantages of the claimed subject matter will become better understood with regard to the following description, appended claims, and accompanying drawings where:

FIG. 1 provides an exemplary architectural flow diagram that illustrates program modules for implementing various embodiments of a “property checker,” as described herein.

FIG. 2 illustrates abstractions computed by the property checker on the example program illustrated in Table 1, as described herein.

FIG. 3 illustrates abstractions computed by the property checker on the example program illustrated in Table 2, as described herein.

FIG. 4 illustrates an example of a refinement split “template” for splitting “regions” at a “frontier,” as described herein.

FIG. 5 illustrates a technique for computing a “WP_{α}” operator that combines a weakest precondition operator with an alias set, α, obtained during execution of a specific test-case, as described herein.

FIG. 6 provides general system flow diagram that illustrates exemplary methods for implementing various embodiments of the property checker, as described herein.

FIG. 7 is a general system diagram depicting a simplified general-purpose computing device having simplified computing and I/O capabilities for use in implementing various embodiments of the property checker, as described herein.

### DETAILED DESCRIPTION OF THE EMBODIMENTS

In the following description of the embodiments of the claimed subject matter, reference is made to the accompanying drawings, which form a part hereof, and in which is shown by way of illustration specific embodiments in which the claimed subject matter may be practiced. It should be understood that other embodiments may be utilized and structural changes may be made without departing from the scope of the presently claimed subject matter.

1.0 Introduction:

In general, a “property checker,” as described herein provides various techniques for performing automated analysis of software or software binaries by using light-weight symbolic execution to prove that software programs satisfy particular “safety properties” (also referred to herein as “properties”) by simultaneously performing program testing and program abstraction. A simple example of a safety property includes a particular program condition that must be satisfied for proper program execution, such as, for example, whether an application properly interfaces with a conventional library function. As is known to those skilled in the art, an abstraction of a software program or procedure is a simplification of that software program that is used in an attempt to prove properties of the software. The simplified system (i.e., the abstraction) usually does not satisfy exactly the same properties as actual program, so that a process of “refinement” may be necessary. A “sound” abstraction is one in which any properties proved on the abstraction are also true of the original software.

The property checker provides at least three significant advances over conventional software testing tools. First, the property checker uses test-case (also referred to herein as “tests”) generation not only to guide where to do refinement of software proofs for proving particular program properties, but also to decide what refinements to apply to the automatically generated tests. In contrast to conventional techniques, no extra theorem prover calls are required to maintain these proofs. However, a theorem prover of the property checker is used to provide test-case generation. Refinement is then is done as a byproduct of a failed test-case generation attempt. Second, in contrast to conventional validation approaches, the property checker handles programs with pointers without using any whole-program may-alias analyses. Specifically, the property checker refines the abstraction in a sound manner using only aliasing relationships that actually arise in a particular test-case. Finally, the property checker also provides an inter-procedural technique that uses recursive invocations of itself to handle procedure calls in the software being validated.

The ability to refine abstractions in a sound manner without using any extra theorem prover calls or global alias analyses provides significant advantages over conventional software testing techniques. For example, conventional theorem provers are slow, and act as a bottleneck in many static analyses. Further, the so-called “may-alias” information obtained from conventional pointer analyses is generally imprecise, which leads to difficulty in constructing an appropriate proof, especially in situations such as binary analysis where a global alias analysis is difficult to obtain.

For example, in a tested embodiment using the property checker, x86 program binaries are received as an input. Program debugging information is then used to perform type-based pointer discrimination, since ignoring this information would lead to a constant overhead in the size of abstractions. This is because the property checker uses techniques to perform refinement without using may-alias information. A new operator, termed “WP_{α}”, is defined that combines a weakest precondition operator with an alias set, α, that is obtained during execution of the specific test-case that the property checker is attempting to extend. If the test-case generation fails, the predicate WP_{α} (defined in Section 3.3.1) can be used to refine the proof in a sound manner, without using any extra theorem prover calls.

Predicates obtained from the WP_{α} operator are weaker than applying the strongest postcondition on the test-case, and stronger than predicates obtained by applying the usual weakest precondition operator. Consequently, the use of the WP_{α} operator allows the property checker to refine abstractions using only the alias conditions that actually occur in the program during execution. In some cases, this means that the property checker considers abstractions that are exponentially smaller than those considered by conventional techniques that use the weakest precondition operator together with a may-alias analysis.

1.1 System Overview:

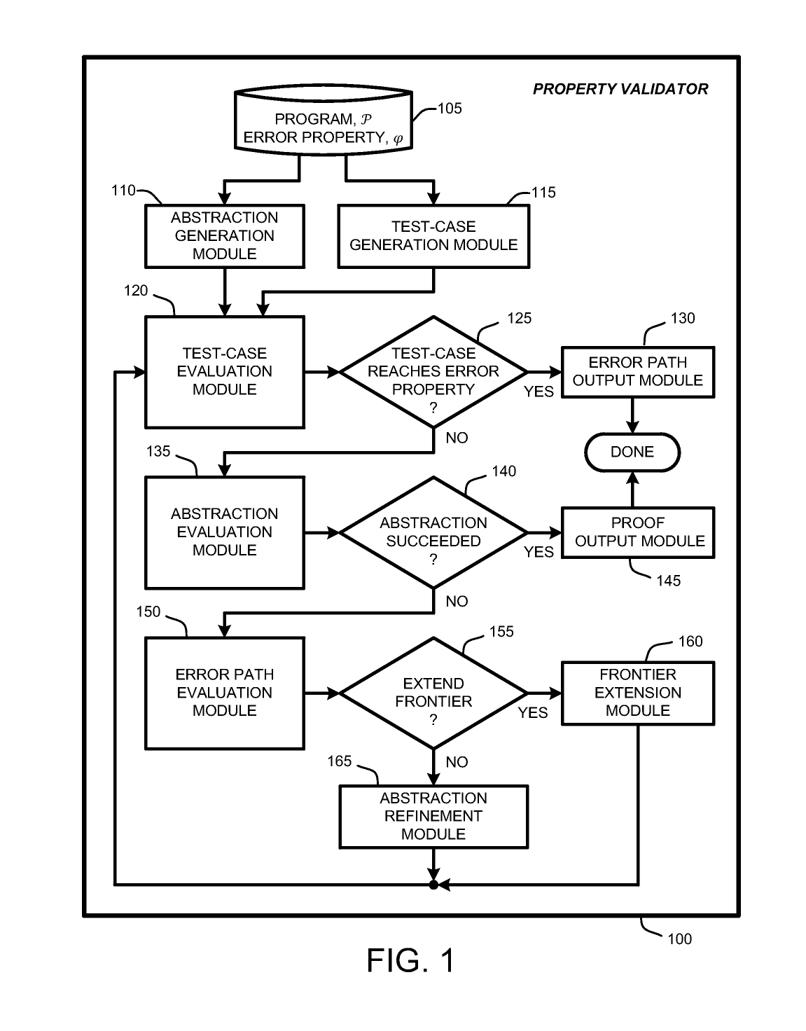

As noted above, the property checker provides various techniques for performing automated analysis of software binaries by using light-weight symbolic execution to prove that software programs satisfy safety properties by simultaneously performing program testing and program abstraction. The processes summarized above are illustrated by the general system diagram of FIG. 1. In particular, the system diagram of FIG. 1 illustrates the interrelationships between program modules for implementing various embodiments of the property checker, as described herein. Furthermore, while the system diagram of FIG. 1 illustrates a high-level view of various embodiments of the property checker, FIG. 1 is not intended to provide an exhaustive or complete illustration of every possible embodiment of the property checker as described throughout this document.

In addition, it should be noted that any boxes and interconnections between boxes that are represented by broken or dashed lines in FIG. 1 represent alternate embodiments of the property checker described herein, and that any or all of these alternate embodiments, as described below, may be used in combination with other alternate embodiments that are described throughout this document. Also, note that the following example addresses a simple case for handling a program with a single procedure, while in general, as described in greater detail in Section 3, the property checker is capable of handling multiple procedures and nested functions through recursive calls to itself.

In general, as illustrated by FIG. 1, the processes enabled by the property checker 100 begin operation by receiving inputs 105 including a program ρ, having one or more procedures, and an error property, φ, that is to be checked by the property checker. The property checker 100 then uses an abstraction generation module 110 to automatically generate an initial abstraction of the software being validated. In addition, the property checker 100 uses a test-case generation module 115 to automatically generate one or more test cases with which to test the abstraction.

Once the property checker 100 has generated the initial test-cases and abstractions, a test case evaluation module 120 evaluates the test cases in view of the abstraction to determine whether a path to the error property, φ, exists. If the test case reaches 125 the error property along a valid error path, then there is an error or “bug” in the program, and the property checker then uses an error path output module 130 to output the specific path by with the error property φ, can be reached. However, if the test case cannot reach 125 the error property along a valid error path, then a abstraction evaluation module evaluates the current abstraction to determine whether that abstraction represents a proof that the there is no possible path to the error property, φ.

If there is no possible path to the error property, φ, then the abstraction has succeeded 140, and a proof output module 145 outputs an indication or proof that the program is valid without any paths to the error property, φ. Conversely, in the case that the abstraction has not succeeded 145 (i.e., the current abstraction has failed), then an error path evaluation module 150 evaluates the error path of the current abstraction to determine whether a “frontier” of the current abstraction can be extended. As described in further detail herein, an “edge” that connects a tested region of the abstract path to the error to an untested successor region of the abstract path to the error is called the “frontier” of the error path of the current abstraction.

If the frontier can be extended 155, then a frontier extension module 160 is used to extend the frontier for further analysis. Following extension of the frontier, the new test case (with the extended frontier) is passed to the test-case evaluation module 120 along with the current abstraction. The processes described above are then repeated to determine whether the current test case reaches 125 the error property based on the current abstraction, or whether the current abstraction has succeeded 140 in proving that the error property cannot be reached.

If the frontier cannot be extended 155, then an abstraction refinement module 165 is used to refine the current abstraction of the current test case by splitting states of the current abstraction, and determining new edges corresponding for the split states, as described in further detail herein. Following refinement of the abstraction, the new abstraction is passed to the test-case evaluation module 120 along with the current test-case. The processes described above are then repeated to determine whether the current test case reaches 125 the error property, φ, based on the current abstraction, or whether the current abstraction has succeeded 140 in proving that the error property cannot be reached.

The processes described above then continue until either the current test case reaches 125 the error property, φ, thus confirming the existence of a program “bug,” or until the property checker 100 proves the validity of the program by “proving” that there is no possible path the error property, φ.

2.0 Overview and Examples of the Property Checker:

The above-described program modules are employed for implementing various embodiments of the property checker. As summarized above, the property checker provides various techniques for performing automated analysis of software binaries to prove that software programs satisfy particular safety properties. The following sections provide a detailed discussion of the operation of various embodiments of the property checker, and of exemplary methods for implementing the program modules described in Section 1 with respect to FIG. 1. In particular, the following sections describe examples and operational details of various embodiments of the property checker, including: an operational overview and examples of the property checker; an example of lazy alias analysis; the use of a frontier for test-case generation; and inter-procedural property checking.

2.1 Operational Overview:

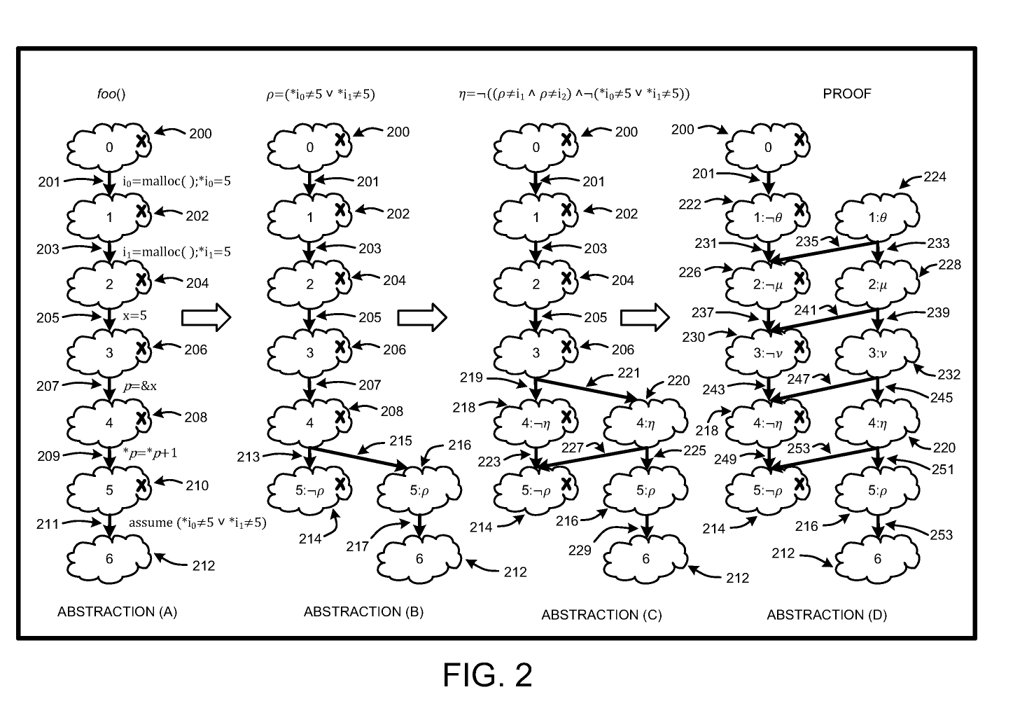

In general, the property checker acts to validate programs with potentially infinite state spaces, denoted by “Σ”. A finite indexed partition, Σ_{≃}, is used as an abstraction of Σ. A graphical representation of this abstraction idea is represented by FIG. 2, where abstractions are shown as “clouds” (even numbered elements from 200 to 232) connected by edges (odd numbered elements from 201 to 253). Each “cloud” is an equivalence class from Σ_{≃} that represents a possibly infinite set of “concrete states” from Σ (i.e., those states that are actually reachable in view of the software being validated). Abstractions have an edge from one cloud to another if there exist two states s₁ and s₂ such that s₁ is in the first cloud, s₂ is in the second cloud, and there is a concrete transition from s₁ to s₂. The initial abstraction (denoted as “Abstraction (A)”) chosen by the property checker is simply the control flow graph of the program being evaluated (see the discussion in Section 2.2 regarding the program example provided in Table 1). Thus, each cloud in the initial representation represents the set of all states such that the program counter has a particular value.

In addition, the property checker simultaneously maintains a set of tests of the program. Since it is assumed that the only non-determinism in programs occur from the inputs, a test-case is fully specified by a logical input map giving values to input pointers and variables. Further, since the property checker uses test-cases to construct a proof of the program, it stores not only these initial values but also a “forest” F of all the states visited by the test-cases (i.e. those states that are “concrete”). Pictorially, the states in this forest are represented using the symbol “×”inside particular clouds when all states in the particular cloud have been visited, as illustrated in FIG. 2 for a number of the clouds.

In general, the inputs to the property checker consist of a program P and an error region, φ. Given these inputs, the property checker can succeed in one of two ways. First, if the property checker manages to grow the forest of tests such that it visits all states in a particular cloud corresponding to the error region φ, it has found a concrete trace (represented by the concrete test in F) that leads to the error (or software “bug”). Second, if the property checker manages to refine the abstraction of the program such that there is no path in the abstraction Σ_{≃} from a cloud representing initial states to a cloud representing error states, then the current abstraction Σ_{≃} is a proof that there is no path from any initial state to any state in the error region φ.

The property checker proceeds by picking a path τₑ from the initial region to the error region in the abstraction Σ_{≃} and then attempting to grow the forest F along this path using test-case generation techniques. These techniques perform a light-weight symbolic execution along the path Σₑ, and collect constraints at every state as functions of the inputs to the program. In programs with pointers, the symbolic execution along τₑ is done in a “pointer aware” manner keeping track of the aliases between input variables in the program. An important point in understanding the property checker is that if a test-case generation attempt fails, then there is enough information to refine the abstraction Σ_{≃} without making any extra theorem prover calls. A new operator, WP_{α}, is defined that can generate such a refinement. The WP_{α} operator specializes the weakest precondition operator using only the alias conditions that occur along the test.

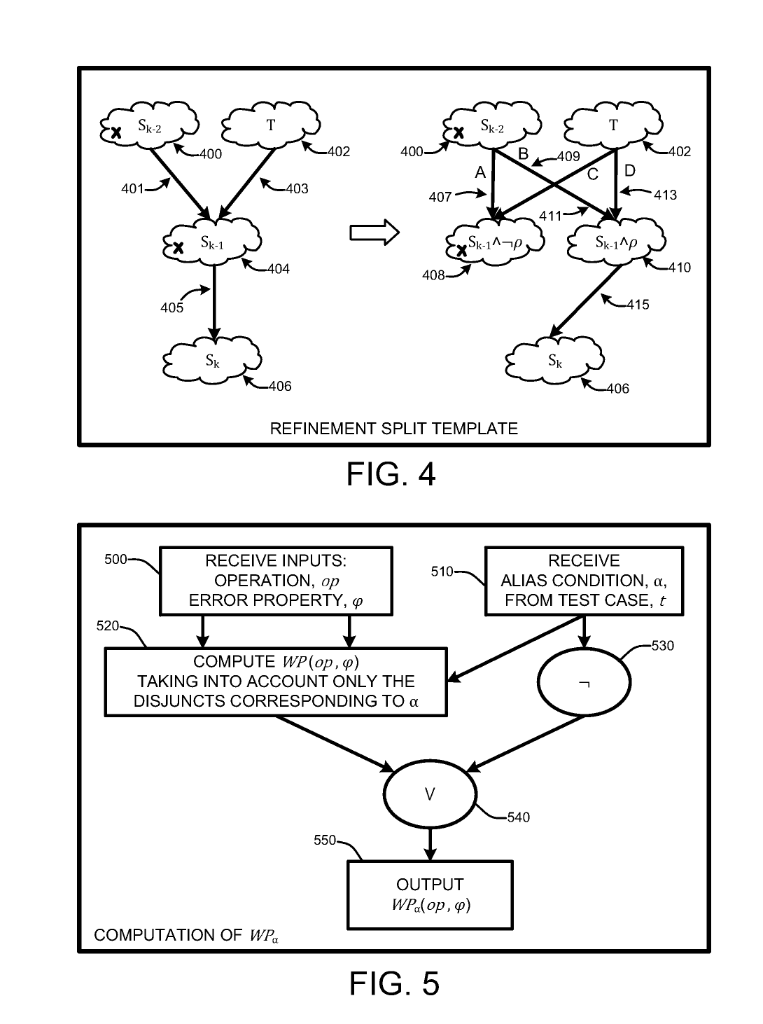

When the property checker refines a region with the predicate generated by the WP_{α} operator, the property checker generates a large number of new edges if the region being refined has many parents or many children. Conventional techniques that maintain a program abstraction will generate a theorem prover call in an attempt to remove each of these new edges. In contrast, the property checker removes only the single edge that is known to be infeasible as a result of the failure to generate a test-case. This template-based refinement, described below with respect to FIG. 4 is a “lazy maintenance” of program abstractions, discussed below with respect to the concept of “lazy alias analysis.” In other words, while the property checker may make more iterations than other techniques, each such iteration will be light-weight in nature.

2.2 Lazy Alias Analysis:

In general, the concept of “lazy alias analysis” can be described with respect to the simple program example illustrated in Table 1 with respect to FIG. 2. In particular, consider the program example shown in Table 1 which has a single input given by “int *ρ,” which is simply a pointer to an integer. In this example, the input ρ is updated to point to the address of variable x at line 4 (i.e., “ρ=&x”). Thus, as illustrated by Table 1, the assignment to *ρ at line 5 updates x indirectly. There are two other local variables *i₀, and *i₁ that are both initialized to 5 in lines 1 and 2, respectively, and the error state is reached in line 7 only if their values change. Note that in this simple example, ρ may alias i₀ or i₁ due to assignments at lines 8 and 9. Thus, a conventional flow-insensitive may-alias analysis will have to conservatively assume that at the assignment at line 5, the variable p may alias with &x, i₀ or i₁, and consider all possible alias combinations. However, as discussed in further detail below, the property checker is able to use automatically generated test-cases to prove that the program is correct while only ever considering the alias combination (ρ=&x Λρ≠i₀Λρ≠i₁) that occurs along the concrete execution of the test.

TABLE 1
Program Example #1

Void
foo(int * p)
{
0: int x, *i₀, *i₁;
1: i₀ = malloc( ); *i₀ = 5;
2: i₁ = malloc( ); *i₁ = 5;
3: x = 5;
4: p = &x;
5: *p = *p + 1;
6: if (*i₀ Ø = 5 || *i₁ Ø = 5 Ø)
7: error( );
8: p = i₀;
9: p = i₁;
}

In other words, as illustrated by Abstraction (A) in FIG. 2, the property checker first creates the abstraction Σ_{≃} for the program “foo.” Note that this abstraction is isomorphic to the control flow graph of program foo, since it is obtained by maintaining just the program location as the abstract state. Next, the initial forest, F, is created by running foo with a random test that assigns some value to ρ, thus creating a forest F_{foo} of concrete states.

Since running this test did not result in the error location being reached (i.e., there is no × representing a concrete state in the cloud 212 corresponding to the error region 6), the property checker examines an (abstract) error path τₑ with prefix τ in Σ_{≃foo} such that:
a) There exists a path in the forest of tests F_{foo} corresponding to the prefix τ; and
b) No abstract state in τₑ after τ has a concrete state from F_{foo}.

The edge that connects the tested region in the prefix τ to the untested successor region in τₑ is called the “frontier” of the trace τₑ. Let τₑ be the path {0, 1, 2, 3, 4, 5, 6} of program locations (i.e., clouds 200, 202, 204, 206, 208, 210, and 212), with prefix τ={0, 1, 2, 3, 4, 5} (i.e., clouds 200, 202, 204, 206, 208, and 210), as illustrated in FIG. 2. The property checker now tries to add a test to F_{foo} that follows τₑ for at least one transition beyond the prefix τ by using directed testing, that is, a test that covers the transition. It turns out that in this particular case, such a test is not possible due to the coding of the example software code illustrated in Table 1. Therefore, in this example, the property checker refines the abstract state using the WP_{α} operator, (described in detail in Section 3.3.1). In this case, the WP_{α} operator returns the predicate ρ=(i₀≠5 V i₁≠5). The property checker then splits the partition 5 into two partitions, “5: [symbol] o” and “5:ρ” (clouds 214 and 216, respectively) to construct “Abstraction (B)” as illustrated in FIG. 2. Note that the symbol “ [symbol] ” represents a logical negation, such that the statement “5: [symbol] ρ” is true if and only if the statement “5:ρ” is false.

Due to the properties of the WP_{α} operator, the property checker can now refine the current abstraction at the frontier (which is the region 5 shown as cloud 210) according to the template described below with respect to FIG. 4. As illustrated by Abstraction (B) of FIG. 2, this refinement can be done without any theorem prover calls. It involves simply deleting the edge 211 between regions 5 and 6 (i.e., clouds 210 and 212, respectively), expanding region S into two partitions, “5: [symbol] ρ” and “5:ρ” (i.e., clouds 214 and 216, respectively), and adding a new edge 213 between region 4 (cloud 208) and partition “5: [symbol] o” (cloud 214) denoted as “(4,5: [symbol] ρ)”, a new edge 215 between region 4 and partition “5:ρ” (cloud 216) denoted as “(4,5:ρ)”, and a new edge 217 between partition “5:ρ” and region 6 (cloud 212) denoted as “(5:ρ, 6)” resulting in the refined abstraction shown in abstraxtion (B) of FIG. 2.

Next, the property checker continues by choosing a new abstract error path τₑ={0, 1, 2, 3, 4, 5:ρ, 6} (i.e., clouds 200, 202, 204, 206, 208, 216, and 212), with prefix τ={0, 1, 2, 3, 4} (i.e., clouds 200, 202, 204, 206, and 208), and tries to drive a test along the transition (4,5:ρ), (i.e., edge 215 between clouds 208 and 216). This transition is also not possible, so the property checker uses the WP_{α} operator to obtain the new predicate η= [symbol] ((ρ≠i₀ [symbol] ρ≠i₁) [symbol] (i₀≠5 [symbol] i₁≠5)). Intuitively, the sub-expression α=(ρ≠i₀ [symbol] ρ≠i₁) corresponds to the alias relations that hold between the variables ρ, i₀, and i₀. The sub-expression (i₀≠5 [symbol] i₁≠5) is the weakest precondition along the transition (4,5:ρ) (i.e., edge 215 between clouds 208 and 216) assuming the alias constraints imposed by α. As with region 5 (cloud 210), region 4 (cloud 208) can be refined by applying the template from FIG. 4 without using any additional theorem prover calls, resulting in the refined abstraction shown in “Abstraction (C)” of FIG. 2, where region 4 is split into two partitions, “4: [symbol] η” and “4:η” (i.e., clouds 218 and 220, respectively). In addition, new edges 219, 221, 223, 225, 227, and 229 are added as illustrated in Abstraction (C) of FIG. 2.

The property checker then continues by choosing a new abstract error path, in the same manner as described above, and eventually computes a “proof” of correctness as shown in “Abstraction (D)” of FIG. 2. Note that conventional techniques which use the well-known Morris' general axiom of assignment to handle pointer aliases soundly, have to consider 6 possible aliases, as follows:

a) ρ=&x or ρ≠&x

b) ρ=i₀ or ρ≠i₀

c) ρ=i₁ or ρ≠i₁

In contrast, the property checker considers only a single alias possibility:

a) ρ=&x [symbol] ρ≠i₀ [symbol] ρ≠i₁

that occurs along the concrete execution of the test, resulting in exponential savings in the size of the proof of correctness relative to conventional techniques based on Morris' general axiom of assignment.

2.3 Use of the Frontier for Test-Case Generation:

Suppose the property checker is examining an abstract trace S₀, S₁, . . . , Sₙ, where S₀ is an equivalence class that contains initial states, Sₙ is an equivalence class that contains error states, and for every 0≦i<n, there is an edge in the abstraction Σ_{≃} from Sᵢ to Sᵢ₊₁. One way to perform refinement is to start with the error region Sₙ and perform repeated conventional preimage computations to propagate the error “backwards” and find the first index where the intersection becomes null. With conventional systems, to detect the first place where the intersection becomes null, a theorem prover call is needed at every step of the trace, and in the worst case, the number of theorem prover calls will be as expensive as the length of the trace.

Another conventional approach to address this problem is to start with the first region S₀, and perform conventional strongest postcondition operations and propagate the initial state “forwards” until the first index where the intersection becomes null is found. Again, with this type of conventional system, a theorem prover call is needed to check if the intersection is null at every step of the trace. Alternatively, suitable interpolants can be computed at every point in the trace using conventional techniques. Unfortunately, such techniques also require a theorem prover call at every step of the trace to refine the abstraction.

In contrast to these conventional approaches, the property checker completely avoids the computationally expensive step of searching for where to refine abstractions by using automatically generated test cases. In particular, the property checker uses the frontier to generate test-cases that will drive a test towards the error region along the abstract error trace. In the event of a failed test-case generation, the property checker has enough information to know that the frontier is a suitable refinement point without having to do any further theorem prover calls.

In particular, as shown in the proof presented as “Lemma 1” in Section 3.3.1, the property checker uses the WP_{α} operator to compute a refinement at the frontier that is guaranteed to make progress, without making any extra theorem prover calls. Note that this technique differs from conventional abstraction refinement algorithms that typically require several theorem prover calls to build the abstraction once a refinement predicate is chosen. Thus, every abstraction refinement iteration performed by the property checker is considerably more efficient than conventional abstraction techniques since the property checker avoids the computational overhead of requiring extra theorem prover calls.

Note that the property checker may have to perform more abstraction refinement iterations than conventional techniques. However, while conventional refinement techniques refine multiple regions in a single iteration, the effect of the template-based refinement provided by the property checker is that once a new predicate is discovered, it is lazily propagated backward one step at a time through only those regions which are discovered to be relevant, as described in further detail in the following Sections. Therefore, the computational overhead of several refinement iterations of the property checker are roughly comparable to the computational overhead of a single iteration of conventional abstraction refinement tools.

2.4 Inter-Procedural Property Checking:

For software programs with two or more procedures, P, the property checker provides a modular approach to provide program validation. First, the ideas of “forests” and “abstractions” are extended to programs with multiple procedures by maintaining a separate forest Fₚ and a separate abstraction Σ_{≃p} for every procedure P. The only case where the property checker needs to be further generalized is when the frontier that the property checker is trying to extend happens to be a procedure call-return edge (S, T). In this case, the property checker simply invokes itself recursively on the called procedure, by appropriately translating the constraint induced by the path into appropriate initial states of the called procedure, and translating the predicate on the target region T into appropriate error states of the called procedure.

This idea of recursion can be explained using the example program provided in Table 2, where procedure “top” that makes two calls to an increment procedure “inc.” As discussed below, it can be shown that the property checker proves that the call to error( ) (statement 4 in top) is unreachable.

TABLE 2
Program Example #2

Void
top(int x)
{
0: int a, b;
1: a = inc(x);
2: b = inc(a);
3: if (b Ø = x + 2)
4: error( );
5: return;
}
int inc(int y)
{
0: int r;
1: r = y + 1;
2: return r;
}

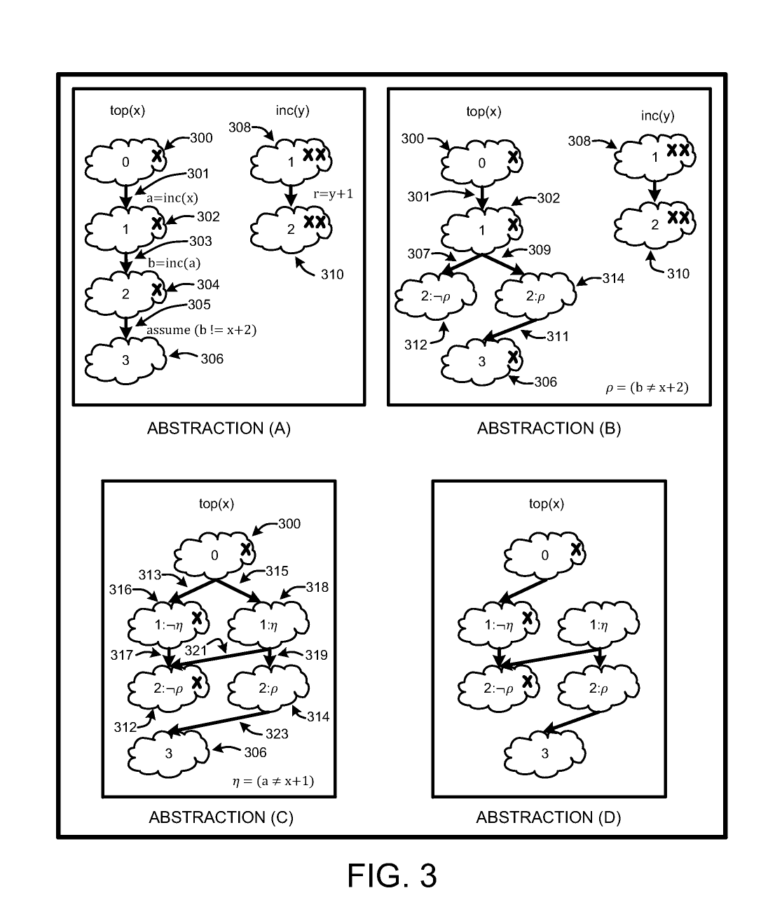

The property checker first creates the abstractions Σ_{≃top} and Σ_{≃inc} for the procedures top and inc respectively (shown in ABSTRACTION (A) of FIG. 3). Note that these abstractions are isomorphic to the control flow graphs of their respective procedures, since they have been computed by maintaining just the program location as the abstract state. Next, the initial forests are created by running a random test (say x=2, for example) for top, thus creating a forest of concrete states in the regions (clouds 302 to 306) illustrated in FIG. 3. Note that it is assumed that that every concrete state, marked with the symbol “×” is connected to its parent within a procedure for each procedure, i.e., top and inc in this example. Since running the test did not result in the error location being reached (there is no concrete state × in the error state 3), the property checker examines an abstract error path τₑ={0, 1, 2, 3} with prefix τ={0, 1, 2} in the abstractions Σ_{≃top} (shown as Abstraction (A) in FIG. 3).

The property checker then tries to add a test to the forest for procedure top, Fₜₒₚ, that follows τₑ for at least one transition beyond the prefix τ by using directed testing, that is, a test that covers the transition from region 2 to region 3 (i.e., cloud 304 to cloud 306). In this particular software example, such a test is not possible since the state in region 3 is not reachable from the state in region 2 given the initial conditions (in other words, it is not possible since the expression (b !+x+2) will not evaluate as true in this case).

Therefore, in this example, the property checker refines the abstraction Σ_{≃top} by removing the abstract transition (i.e., edge 305) from region 2 to region 3 (also denoted as “(2, 3)”) as illustrated in Abstraction (B) of FIG. 3. This refinement is done using the WP_{α} operator that returns the predicate ρ=(b≠x+2). Then, applying the template from FIG. 4, the property checker refines region 2 (cloud 304) of the top procedure into two partitions “2: [symbol] ρ” and “2:ρ” (i.e., clouds 312 and 314, respectively). This refinement further includes adding a new edge 307 between region 1 (cloud 302) and partition “2: [symbol] ρ” (cloud 312) denoted as “(1, 2: [symbol] ρ)”, a new edge 309 between region 1 and partition “2:ρ” (cloud 314) denoted as “(1, 2:ρ)”, and a new edge 311 between partition “2:ρ” and region 3 (cloud 306) denoted as “(2:ρ, 3)” resulting in the refined abstraction for Σ_{≃top} shown as Abstraction (B) in FIG. 3.

Next, continuing from Abstraction (B), the property checker continues by choosing a new abstract error path path τₑ={0, 1, 2: ρ, 3} in the procedure top, with prefix ρ={0, 1}. Since the abstract transition (1, 2:ρ) that is to be tested now corresponds to a call to the procedure inc, the property checker makes a recursive call to itself on the procedure inc. This call to the property checker checks whether a test can be run on inc with a precondition induced by and postcondition induced by the state 2:ρ 314 in top. In this particular case, the recursive call to the property checker returns a “fail” indicating that such a test is not feasible. This “failure” then results in refinement of the abstract state 1 with respect to the predicate η (shown in Abstraction (C) of FIG. 3.

In particular, abstract state 1 is split into two partitions “1: [symbol] η” and “1:η” (i.e., clouds 316 and 318, respectively). This refinement further includes adding a new edge 313 between region 0 (cloud 300) and partition “1: [symbol] η” (cloud 316) denoted as “(0,1: [symbol] η)”, a new edge 315 between region 0 and partition “1:η” (cloud 318) denoted as “(0,1:η)”, a new edge 317 between partition “1: [symbol] η” and partition 2: [symbol] ρ (cloud 312) denoted as “(1 [symbol] η, 2: [symbol] ρ)”, a new edge 319 between partition “1:η” and partition 2:ρ (cloud 314) denoted as “(1η, 2:ρ)”, a new edge 321 between partition “1:η” and partition 2: [symbol] ρ denoted as “(1η, 2: [symbol] ρ)”, resulting in the refined abstraction for Σ_{≃top} shown as Abstraction (C) in FIG. 3. After several more abstraction refinement iterations, the property checker computes the final abstraction Σ_{≃top} (shown as Abstraction (D) in FIG. 3) that proves that the error location (i.e., cloud 306) is unreachable in the procedure top, thereby proving the correctness of procedure top.

Note that the examples provided above are intended as an overview of the abstraction refinement techniques provided by the property checker. Specific details regarding abstraction refinement in view of the aforementioned “refinement template” provided as FIG. 4 are more fully described in Section 3.3.1.

3.0 Operational Details of the Property Checker:

As summarized above, the property checker provides various techniques for performing automated analysis of software programs to prove that software programs satisfy particular safety properties. The following sections provide a detailed discussion of the operation of various embodiments of the property checker, and of exemplary methods for implementing the program modules described in Sections 1 and 2 with respect to FIG. 1, FIG. 2 and FIG. 3. In particular, the following sections describe examples and operational details of various embodiments of the property checker, including: property checker assumptions, syntax and semantics; an algorithmic implementation of the property checker; generation of suitable predicates; soundness and complexity of the property checker; and handling programs with procedure calls.

3.1 Property Checker Assumptions, Syntax and Semantics:

The following discussion considers C programs without arrays or pointer arithmetic. However, it should be clear that the techniques described herein are adaptable to various programming languages, and that th use of C programs as an example is provided only for purposes of explanation with respect to a particular well known programming language. In any case, the following discussion also assumes that the programs being evaluated have been transformed to a simple intermediate form where:
(a) All statements are labeled with a program location;
(b) All expressions are side-effect free and do not contain multiple dereferences of pointers (e.g., (*)^{k>1}p);
(c) Intraprocedural control flow is modeled with “if (e) goto l” statements, where e is an expression and l is a program location;
(d) All assignments are of the form “* m=e”, where m is a memory location and e is an expression.
(e) All function calls (call-by-value function calls) are of the form “*m=f (x1, x2, . . . , xn)”, where m is a memory location.

Given this intermediate format, the following syntax is used to describe the property checker. In particular, let “Stmts” be a set of valid statements in the simple intermediate form described in the preceding paragraph. Formally, a program T is given by a recursive state machine (RSM), where ρ=(P₀, P₁, . . . , Pₙ, where each component procedure Pᵢ={Nᵢ, Lᵢ, Eᵢ, nᵢ⁰, λᵢ, Vᵢ} is defined by the following:
(a) A finite set Nᵢ of nodes, each uniquely identified by a program location from the finite set Lᵢ of program locations;
(b) A set of control flow edges Eᵢ⊂Nᵢ×Nᵢ;
(c) A special start node nᵢ⁰ ∈ Nᵢ which represents the procedure's entry location;
(d) A labeling λᵢ: Eᵢ→Stmts, that labels each edge with a statement in the program. If λᵢ(e) is a function call, then the property checker will refer to the edge e as a call-return edge. The set of all call-return edges in Eᵢ is denoted by by CallRet(Eᵢ); and
(e) A set Vᵢ of variables (consisting of parameters, local variables and global variables) that are visible to the procedure Pᵢ. It is assumed that all l values and expressions are of type either pointer or integer. Additionally, Vᵢ will contain a special variable pcᵢ which takes values from Lᵢ.
   The procedure P₀ is referred to as the “main procedure”, since this is where the execution of the program ρ begins.

The following paragraphs define semantics that are used in describing the property checker. In particular, for purposes of explanation, it suffices to consider only the data state of a procedure, P={N, L, E, n₀, λ, V}. Let ρ be the (possibly infinite) state space of P, defined as the set of all valuations to the variables in V. Every statement, op ∈ Stmts, defines a state transition relation [symbol] : Σ×Σ, and this naturally induces a transition relation, →:Σ×Σ, for the procedure P. Let σ¹ ⊂Σ denote the set of initial states of the procedure P. The symbol [symbol] is used to denote a reflexive and transitive closure of the transition relation →. A property φ⊂Σ is a set of bad states that the property checker does not want do not want the program to reach. An instance of the property checking problem is a pair (P, φ). The answer to (P, φ) is “fail” if there is some initial state, s ∈ σ¹, and some error state, s ∈ φ, such that s [symbol] t, and “pass” otherwise.

The point of this semantic framework is to produce certificates for both “fail” and “pass” answers. A certificate for “fail” is an error trace, that is, a finite sequence, s₀, s₁, . . . , sₙ, of states such that:

(a) s₀ ∈ σ¹;

(b) sᵢ→sᵢ₊₁ for 0≦i≦n; and

(c) sₙ ∈ φ

A certificate for “pass” is a finite-indexed partition, Σ_{≃}, of the state space Σ which proves the absence of error traces. Given an equivalence relation, ≃, on Σ with finitely many equivalence classes, the abstract procedure P_{≃} is defined as P_{≃}={Σ_{≃}, σ¹_{≃}, →_{≃}}, such that:
(a) Σ_{≃} is the set of equivalence classes of ≃ in Σ;
(b) σ¹_{≃}={S ∈ Σ_{≃}|S ∩ σ¹≠0 is the set of equivalence classes that contain initial states; and
(c) S→_{≃}T for S, T ∈ Σ_{≃} if there exist two states s ∈ S and t ∈ T such that s→t. Note that the property checker also allows for the possibility that S→_{≃}T when there do not exist states s ∈ S and t ∈ T such that s→t.

The equivalence classes in Σ_{≃} are referred to as “regions.” Further, let φ_{≃}={S ∈ Σ_{≃}|S ∩ φ≠0 denote the regions in Σ_{≃} that intersect with φ. An abstract error trace is a sequence, S₀, S, . . . , Sₙ, of regions such that:

(a) S₀ ∈ σ¹_{≃};

(b) Sᵢ→_{≃}Sᵢ₊₁ for 0≦i≦n; and

(c) Sₙ ∈ φ_{≃}

The finite-indexed partition Σ_{≃} is a proof that the procedure P cannot reach the error φ if there is no abstract error trace in P_{≃}

3.2 Algorithmic View of the Property Checker:

For purposes of explanation, it will first be assumed that the program ρ={P} has only one procedure, P, as described below with respect to an algorithm describing a function named “PropertyChecker,” as illustrated by the pseudo-code shown in Table 3. Following a discussion of handling programs with a single procedure, a discussion of handling programs with multiple procedures will be provided in Section 3.5.

TABLE 3
Algorithmic Overview of the Property Checker

PropertyChecker(P = {Σ,σ^{I},→},φ)
Returns:
(“fail”, t), where t is an error trace of P reaching φ; or
(“pass”, Σ_{≃}), where Σ_{≃} is a proof that P cannot reach φ.
1: Σ_{≃} := ∪_{lεL}{{(pc,v) ε Σ | pc = l}}
2: σ^{I}_{≃} := {S ε Σ_{≃} | pc(S) is the initial pc}
3: →_{≃} := {(S,T) ε Σ_{≃} × Σ_{≃} | Edge (S,T) ε E}
4: P_{≃} := {Σ_{≃},σ^{I}_{≃},→_{≃}}
5: F := Test(P)
6: loop
7: if φ ∩ F ≠ Ø F then
8: choose s ε φ ∩ F
9: t := TestForWitness(s)
10: return (“fail”, t)
11: end if
12: τ := GetAbstractTrace(P_{≃},φ)
13: if τ = ε then
14: return (“pass”, Σ_{≃})
15: else
16: τ₀ := GetOrderedAbstractTrace(τ,F)
17: {t, ρ} :=ExtendFrontier(τ₀,F,P)
18: if ρ = true then
19: F := AddTestToForest(t,F)
20: else
21: let {S₀,S,...,Sₙ} = τ₀ and
22: (k − 1, k) = Frontier(τ₀) in
23: Σ_{≃} := (Σ_{≃} \ {Sₖ₋₁}) ∪
24: {Sₖ₋₁ [symbol] ρ , Sₖ₋₁ [symbol] ρ}
25: →_{≃} := (→_{≃} \ {(T, Sₖ₋₁)| T ε Parents(Sₖ₋₁)})
26: \{( Sₖ₋₁,T)| T ε (Children(Sₖ₋₁))}
27: →_{≃} := →_{≃} ∪ {(T, Sₖ₋₁ [symbol] ρ) | T ε Parents(Sₖ₋₁)} ∪
28: {(T, Sₖ₋₁ [symbol] ρ) | T ε Parents(Sₖ₋₁)} ∪
29: {(Sₖ₋₁ [symbol] ρ, T ) | T ε (Children(S_{k- 1}))} ∪
30: {(Sₖ₋₁ [symbol] ρ, T ) | T ε (Children(Sₖ₋₁)\{Sₖ})} ∪
31: end if
32: end if
33: end loop

Table 3, shown above, provides an algorithmic overview of various operational embodiments of the property checker which takes the aforementioned property checking instance (P, φ) as an input, and provides one of three possible outcomes, as follows:
(1) The PropertyCheckerfunction may output “fail” together with a test t that certifies that P can reach the error state φ;
(2) The PropertyCheckerfunction may output “pass” together with a proof Σ_{≃} that certifies that the procedure P cannot reach the error state φ; or
(3) The PropertyChecker function may not terminate.

In various embodiments, the PropertyChecker function maintains two basic data structures, as follows:
(1) A finite forest F of states where for every state s ∈ F, either s ∈ σ¹ and parent(s) ∈ F is a concrete predecessor of s (i.e., parent(s)→s), or s ∈ σ¹ and parent(s)=∈; and
(2) A finite-indexed partition Σ_{≃} of the state space Σ of P.

The regions of Σ_{≃} are defined by “pc” values and predicates over program variables. Let pc(S) denote the program location associated with region S, and let Edge(S, T) be a function that returns a control flow edge e ∈ E that connects regions S and T. Initially (see lines 1-4 of Table 3), there is exactly one region for every pc in the procedure P; therefore, the abstract procedure P_{≃} is initially isomorphic to the control flow graph of the procedure P. The function Test (see line 5 of Table 3) tests the procedure P using test-cases (input vectors) for P, and returns the reachable concrete states of P in the form of a forest F (which is empty if no test-cases for P are available). The test-cases for P may come from previous runs of the algorithm, from external test suites, or from automatic test generation tools. Note that the function Test(P) shown in line 5 of Table 3 is used to run the tests generated from previous runs on the same program.

In each iteration of the main loop (lines 6 through 33 of Table 3), the algorithm either expands the forest F to include more reachable states (to see if this expansion will help produce a “fail” answer), or refines the partition Σ_{≃} (and checks to see if this refinement will produce a “pass” answer). The algorithm locates a path from an initial region to the error region through the abstract procedure, and then discovers the boundary (i.e., the frontier) along this path between regions which are known to be reachable and a region which is not known to be reachable. Directed test-case generation is then used to expand the forest F with a test-case that crosses this frontier. If such a test cannot be created, the property checker refines the partition Σ_{≃} at this “explored” side of the frontier. Thus, abstract error traces are used to direct test-case generation, and the non-existence of certain kinds of test-cases is used to guide the refinement of P_{≃}.

During every iteration, the property checker first checks for the existence of a test reaching the error (see line 7 of Table 3). If there is such a test, then φ ∩ F ≠0, so the property checker chooses a state s ∈ ∩ F and calls the auxiliary function “TestForWitness” (shown in line 9 of Table 3) to compute a concrete test that reaches the error. The TestForWitness function (line 9) uses the parent relation to generate an error trace. Specifically, this function starts with a concrete state s and successively looks up the parent until it finds a concrete state s₀ (a root of F) that is an initial region. TestForWitness(s) returns the state sequence s₀, s₁, . . . , sₙ such that sᵢ→sᵢ₊₁ for all 0≦i<n.

If no test to the error exists in the forest F, the property checker then calls the GetAbstractTrace function shown in line 12 of Table 3 to find an abstract error trace through the abstract graph. If no such trace exists, then the current partition Σ_{≃} is a proof that P cannot reach any state in φ, and GetAbstractTrace returns τ=∈. Otherwise, GetAbstractTrace returns the abstract trace τ=S₀, S₁, . . . , Sₙ such that Sₙ=φ. The next step is to convert this trace onto an ordered abstraxt trace. An abstract trace, S₀, S₁, . . . , Sₙ, is ordered if the following two conditions hold:
(1) There exists a frontier (k−1, k) d Frontier(S₀, S, . . . , Sₙ) such that:
   a. 0≦k≦n;
   b. Sᵢ ∩ F≠0 for all k≦i≦n; and
   c. Sⱼ ∩ F≠0 for all 0≦j≦k; and
(2) There exists a state s ∈ Sₖ₋₁ ∩ F such that Sᵢ=Region(parent^{k-1-i}(s)) for all 0≦i<k where the abstraction function Region maps each state s ∈ Σ to the region S ∈ Σ_{≃} with s ∈ S.

Note that whenever there is an abstract error trace, then an ordered abstract error trace must also exist. The auxiliary function GetOrderedAbstractTrace (see line 16 of Table 3) converts an arbitrary abstract trace into an ordered abstract trace, τₒ. This works by finding the last region in the abstract trace that intersects with the forest F. This last region is termed S_{f}. The property checker then picks a state in this intersection and follows the parent relation back to an initial state. This leads to a concrete trace, s₀, s₁, . . . , sₖ₋₁, that corresponds to an abstract trace, S₀, S₁, . . . , Sₖ₋₁, where Sₖ₋₁=S_{f}. By splicing together this abstract trace and the portion of the abstract error trace from S_{f} to Sₙ, the property checker obtains an ordered abstract error trace. Note that it is crucial that the ordered abstract error trace follows a concrete trace up to the frontier, as this ensures that it is a feasible trace up to that point.

Next, as illustrated by the pseudo-code shown in Table 3, the property checker calls the function ExtendFrontier (see line 17 of Table 3). Pseudo-code representing the function ExtendFrontier is further detail in Table 4, as follows:

TABLE 4
Pseudo-Code for the ExtendFrontier Function

ExtendFrontier(τ,F,P)
Returns:
{t,true}, if the frontier can be extended; or
{ε,ρ}, if the frontier cannot be extended.
1: (k − 1,k) := Frontier(τ)
2: (φ₁,S,φ₂) := ExecuteSymbolic(τ,F,P)
3: t := IsSAT(φ₁,S,φ₂,P)
4: if t = ε then
5: ρ := RefinePred(S,φ₂,τ)
6: else
7: ρ := true
8: end if
9: return {t,ρ}

Note that the function ExtendFrontier, defined in the pseudo-code of Table 4, is the only function used by the property checker that uses a theorem prover. It takes an ordered trace τₒ, a forest F, and procedure P as inputs and returns a pair {t,ρ}, where t is a test and ρ is a predicate. They can take the following values:
(a) {t, true}, when t is a test that extends the frontier. The test t is then added to the forest F by AddTestToForest (see line 19 of Table 3), which runs an instrumented version of the program to obtain the trace of concrete states that are added to F.
(b) {∈, ρ}, when no test that extends the frontier is possible. In this case, ρ is a suitable refinement predicate that is used to used to refine the partition Σ_{≃} at the frontier (lines 21-30 of Table 3), resulting in a split of region Sₖ₋₁ (as shown in the refinement split template provided in FIG. 4) that eliminates the spurious abstract error trace τₒ.

The function ExecuteSymbolic, which is called at line 2 of the ExtendFrontier function shown in Table 3, performs symbolic execution on τ. In particular, let τ={S₀, S₁, . . . , Sₙ} and let (k−1, k)=Frontier(τ). Then, the ExecuteSymbolic function returns {φ₁, S, φ₂}, where φ₁ and S are, respectively, the path constraint and symbolic memory map obtained by performing symbolic execution on the abstract trace {S₀, S₁, . . . , Sₖ₋₁}, and φ₂ is the result of performing symbolic execution on the abstract trace {Sₖ₋₁, Sₖ} (not including the region Sₖ₋₁) starting with the symbolic memory map δ. The ExecuteSymbolic function is further described by the pseudo-code provided in Table 5.

In particular, as illustrated below by the pseudo-code provided in Table 5. The ExecuteSymbolic function first initializes the symbolic memory map δ with ν [symbol] ν₀ for every input variable *ν in the program, where ν₀ is the initial symbolic value for *ν (line 2 in Table 5) and performs symbolic execution in order to compute φ₁ and φ₂. The function SymbolicEval(e, δ) evaluates the expression e with respect to values from the symbolic memory δ.

TABLE 5
Pseudo-Code for the ExecuteSymbolic Function

ExecuteSymbolic(τ,F,P)
Returns: (φ₁,S,φ₂)
1: (k − 1,k) := Frontier(τ = {S₀,S₁,...,Sₙ})
2: [symbol] := [v [symbol] v₀| * v ε inputs(P)]
3: let φ₁ = SymbolicEval(Sₒ,S) and φ₂ = true in
4: while i ≠ k − 1 do
5: op := λ(Edge(Sᵢ,Sᵢ₊₁))
6: match(op)
7: case(* m = e):
8: [symbol] := [symbol] + [SymbolicEval(m,S) [symbol] SymbolicEval(e,S)]
9: case(if e goto l)
10: φ₁ := φ₁ [symbol] SymbolicEval(e,S)
11: i: = i + 1
12: φ₁ := φ₁ [symbol] SymbolicEval(Sᵢ,S)
13: end while
14: op := λ(Edge(Sₖ₋₁,Sₖ))
15: match(op)
16: case(* m = e):
17: φ₂ = φ₂ [symbol]
18: * (SymbolicEval(m,S)) = SymbolicEval(e,S)
19: [symbol] := [symbol] + [SymbolicEval(m,S) [symbol] SymbolicEval(e,S)]
20: case(if e goto l)
21: φ₂ := φ₂ [symbol] SymbolicEval(e,S)
22: [symbol] := [symbol]
23: φ₂ := φ₂ [symbol] SymbolicEval(Sₖ, [symbol] )
24: return {φ₁, [symbol] ,φ₂}

Next, the ExtendFrontier function, defined in the pseudo-code of Table 4, calls the function IsSAT (see line 3 of the pseudo-code in Table 4) that checks whether μ=φ₁ [symbol] δ [symbol] φ₂ is satisfiable by making a call to a theorem prover. Note that every entry in δ is looked upon as an equality predicate here. If μ is satisfiable, IsSAT uses the satisfying assignment/model to generate a test t for P that extends the frontier, otherwise it sets t=∈. If it is not possible to extend the frontier (that is, t=∈, as shown in line 4 of Table 4), then ExtendFrontier calls RefinePred (see line 5 of Table 4) which returns a predicate, ρ, that is a suitable candidate for refining Σ_{≃} at Sₖ₋₁ according to the abstraction refinement template illustrated in FIG. 4. It is useful to note that RefinePred makes no theorem prover calls in order to compute the predicate, ρ.

3.3 Suitable Predicates:

If the property checker cannot drive a test-case past the frontier, then the RefinePred function should return a predicate that is in some sense “good.” For example, considering the general predicate refinement template illustrated in FIG. 4, there are definitely two ways in which a refinement predicate can be bad. First, if ρ is too weak, then it will be possible to derive a test along the same ordered abstract trace, in which case RefinePred will be called with the exact same arguments and will return ρ again. Alternatively, if ρ is too strong, then there may be a transition from some region in Sₖ₊₁ [symbol] ρ to some region in Sₖ, and there is no justification for removing the edge between these two regions. By formalizing the notion of a suitable predicate, it can be shown that any suitable predicate will allow the property checker to make progress in a sound manner, and also that the predicate returned by the RefinePred function is a suitable predicate.

DEFINITION 1 (Suitable Predicate): Let τ be an abstract error trace and let (S, T) be its frontier. A predicate ρ is said to be suitable with respect to τ only if all possible concrete states obtained by executing τ up to the frontier belong to the region S [symbol] ρ, and if there is no transition from any state in S [symbol] ρ to a state in T.

Given two abstract error traces τ={S₀, S₁, . . . , Sₙ} and τ′={T₀, T₁, . . . , Tₙ} of the same length, then τ [symbol] τ′ if either of the following conditions is true:
(1) ∀_{0≦i≦n}Tᵢ⊂Sᵢ, and ∃k ∈ [0, n] such that Tₖ⊂Sₖ; or
(2) Let (x, x+1)=Frontier(τ) and (y, y+1) =Frontier(τ′), then ∀_{0≦i≦n}Tᵢ=Sᵢ, and y>x.

Essentially, this means that τ [symbol] τ′ if τ′ is a strictly “better” trace, either because the frontier in τ′ has been pushed forward or because at least one region in τ′ holds strictly fewer states. This is formalized below by Definition 2:

DEFINITION 2 (Progress): Let Γ={τ₀, τ₁, . . . } be a sequence of abstract error traces examined by the property checker. Then it is said that the property checker makes “progress” if there do not exist i and j such that i<j and τⱼ [symbol] τᵢ.

THEOREM 1: If a suitable predicate for an abstract error trace τ is used to perform refinement, then the property checker algorithm makes progress.

PROOF of THEOREM 1: Let τ={S₀, S₁, . . . , Sₙ}. By definition (see FIG. 4), it follows that a suitable predicate ρ with respect to τ would eliminate edge (Sₖ₋₁, Sₖ) in a sound manner by splitting Sₖ₋₁ into two regions, Sₖ₋₁ [symbol] ρ and Sₖ₋₁ [symbol] ρ. Since all concrete states in Sₖ₋₁ that can be obtained by traversing the abstract error trace belong to the region Sₖ₋₁ [symbol] ρ, and the edge (Sₖ₋₁ [symbol] ρ, Sₖ) does not exist, it follows that Definition 2 is satisfied if a refinement is performed on any of the states. Alternatively, if a test is generated, then the second condition in Definition 2 is satisfied, thus proving Theorem 1.

COROLLARY 1: A suitable predicate ensures that the refinement is sound.

Theorem 1 allows the property checker to perform template-based refinement (as shown in FIG. 4) without any calls to a theorem prover after computing a suitable predicate. The following paragraphs describe how the aforementioned auxiliary function RefinePred computes a suitable predicate.

3.3.1 Computing Suitable Predicates:

In general, abstractions are split using a template, see FIG. 4 to split one state or region into two new regions based on the underlying code of the particular state being evaluated. For example, a simple abstraction with states {Sₖ₋₂, T, Sₖ₋₁, Sₖ}, (i.e., clouds 400, 402 404 and 406, respectively), with edges 401, 403, and 405, is split as illustrated. Specifically, state Sₖ₋₁ (cloud 404) is split into state Sₖ₋₁ [symbol] ρ (cloud 408) and state Sₖ₋₁ [symbol] ρ (cloud 410) by determining a suitable predicate, ρ, for the state being split. Since the region Sₖ₋₁ (cloud 404) is split into two states, there are four new edges A, B, C, and D, (edges 407, 409, 411 and 413, respectively) that can be used to complete the abstraction. One or more of these edges are then removed via the refinement processes described herein.

For a statement op ∈ Stmts and a predicate φ, let WP(op,φ) denote the “weakest precondition” of φ with respect to statement op. WP(op,φ) is defined as the weakest predicate whose truth before op implies the truth of φ after op executes. The weakest precondition WP(x=e, φ) is the predicate obtained by replacing all occurrences of x in φ (denoted φ[e/x]). For example, in view of the preceding discussion, WP(x=x+1, x<1)=(x+1)<1=(x<0). However, in the case of pointers, WP(op,φ) is not necessarily φ[e/x]. For example, WP(x=x+1,*p<1) is not *p<1, if x and * p are aliases. In order to handle this, if the predicate φ mentions k locations (say y₁,y₂, . . . ,yₖ), then WP(x=e,φ) would have 2^{k} disjuncts, with each disjunct corresponding to one possible alias condition of the k locations with x. Note that a “location” is defined here as either a variable, a structure field access from a location, or a dereference of a location. Therefore,

WP(x=x+1,*p<1)=(&x=ρ [symbol] x<0)V(&x≠p [symbol] *p<1)

Typically, a whole-program may-alias analysis is used to improve precision (i.e., prune the number of disjuncts) of the weakest precondition. This analysis largely influences overall system performance. From FIG. 4, it is easy to see that ρ=WP(op,Sₖ) (where op is the statement associated with edge (Sₖ₋₁, Sₖ)) is a suitable predicate. On the other hand, the predicate [symbol] (φ₁ [symbol] S) (where {φ₁, S, φ₂}=ExecuteSymbolic(τ, F, P) in the pseudo-code illustrated in Table 4) corresponding to the forward symbolic path constraint is also a valid suitable predicate.

Table 6, provided below, provides pseudo-code that describes the RefinePred function.

TABLE 6
Pseudo-Code for the RefinePred Function

RefinePred(S,φ₂,τ)
Returns: a suitable predicate, ρ
1: (k − 1,k) := Frontier(τ = {S₀,S₁,...,Sₘ})
2: op := λ(Edge(Sₖ₋₁,Sₖ))
3: α := Aliases( [symbol] ,op,φ₂)
4: return WP_{α}(op,φ₂)

RefinePred is a function that uniformly combines the forward symbolic path constraint (for tracking alias conditions) and weakest preconditions (for arithmetic constraints) judiciously to compute a suitable predicate. Note that this enables the property checker to consider aliases in a path-sensitive manner without any alias analysis. Moreover, this is done by using information that was already computed in the process of trying to extend the frontier with a test case. Note that this differs significantly from conventional validation techniques that perform a whole-program may-alias analysis on the input program. Any imprecision in that type of conventional alias analysis adversely affects the performance of those conventional program validation tools. In contrast, the property checker discovers the alias constraints on the fly from the automatically constructed test cases and uses them to perform refinement.

Specifically, the RefinePred function first gets the statement op associated with the frontier edge (see line 2 of the pseudo-code provided in Table 6). The function Aliases then returns the alias relations (from the symbolic memory δ) between the locations in op and those in φ₂. Therefore, the refinement predicate computed by RefinePred is

$${WP}_{α} ( op , {φ}_{2} ) {=}^{def}$$

where WP↓_{α} (op, φ₂) is the weakest precondition assuming the alias relations defined by α. Note that computation of the WP_{α} operator is illustrated by the flow diagram provided in FIG. 5.

LEMMA 1: The predicate WP_{α}(op, φ₂) computed by the auxiliary function RefinePred is a suitable predicate.

PROOF: There are two parts of this proof for the two requirements of Definition 1 (discussed above in Section 3.3). Let C be the set of concrete states obtained by executing the ordered trace up to the frontier. Any concrete state c ∈ C must satisfy the existing predicate on the region Sₖ₋₁ as well as the alias relations defined by α. Since it is not possible to generate a test that extends the frontier, it must be the case that ∀c ∈ C, c ∈ WP↓_{α} (op, φ₂) (since every path results in exactly one α). This implies that ∀c ∈ C, c ∈ α [symbol] WP↓_{α} (op, φ₂). Therefore, C ∩ [symbol] (α [symbol] WP↓_{α} (op, φ₂))=0;, and so the predicate WP_{α}(op, φ₂) satisfies the first half of Definition 1.

The second part of Definition 1 requires that no state in Sₖ₋₁ [symbol] WP_{α}(op, φ₂) have a transition to a state in Sₖ. Every state that can make this transition satisfies WP_{α}(op, φ₂) by the definition of weakest precondition. Because every state in Sₖ₋₁ [symbol] _{WP}_{α}(op, φ₂) must also satisfy the alias relations defined by α, any state in Sₖ₋₁ [symbol] WP_{α}(op, φ₂) that can transition to Sₖ must satisfy WP↓_{α} (op, φ₂) specifically. Because every state satisfying [symbol] WP_{α}(op, φ₂) also must not satisfy WP↓_{α} (op, φ₂), no states with a transition to Sₖ can exist, and therefore WP_{α}(op, φ₂) is a suitable predicate.

3.4 Soundness and Complexity:

The following paragraphs present theoretical results that characterize the correctness and complexity of the property checker. Lemma 1, discussed above in Section 3.3.1 states that the property checker is sound—that is, every error and proof found by the property checker is a valid one.

LEMMA 2 (Soundness): If the property checker terminates on (P, φ), then either of the following is true:
(1) If the property checker returns (“pass”, Σ_{≃}), then Σ_{≃} is a proof that P cannot reach φ; and
(2) If the property checker returns (“fail”, t), then t is a proof that P that violates φ.

PROOF: If the property checker returns (“pass”, Σ_{≃}), it follows from Corollary 1 and Lemma 1 (as discussed in Section 3.3) that P_{≃}={Σ_{≃}, σ¹_{≃}, →_{≃}} simulates the program P with respect to the property φ and thus is a proof that P cannot reach φ. On the other hand, since the property checker returns (“fail”, t), only if there is a concrete witness in the region φ, the t is a test that violates φ.

Complexity of the property checker algorithm is measured in terms of the number of theorem prover calls per iteration, where every iteration entails either a generation of a test-case (frontier extension) or a suitable predicate (proof refinement).

LEMMA 3 (Complexity). The complexity of the property checker algorithm is precisely one theorem prover call per iteration.

PROOF: During one iteration of the property checker algorithm, a test case generation entails one theorem prover call (i.e., a call to the IsSat function in line 3 of the auxiliary function ExtendFrontier shown in Table 4). If a test that extends the frontier is not possible, then generating a suitable predicate for refinement does not involve a theorem prover call.

3.5 Handling Programs with Multiple Procedures:

Without loss of generality, it is assumed that the property φ that is to be checked is only associated with the main procedure P₀ in the program ρ. Therefore, the procedure VALIDATE-MAIN(ρ={P₀,P₁, . . . , Pₙ}, φ) (provided in Table 7) calls the function PropertyChecker illustrated in Table 3 on the property checking instance (P₀, φ) for the case of programs with multiple procedures.

TABLE 7
Pseudo-Code for the VALIDATE-MAIN Procedure

VALIDATE-MAIN(P,φ)
Returns:
(“fail”, t), where t is an error trace of P reaching φ; or
(“pass”, Σ_{≃}), where Σ_{≃} is a proof that P cannot reach φ
1: let {P₀,P₁,...,Pₙ} = P
2: PropertyChecker (P₀ = {Σ₀,σ₀^{I},→₀},φ)

As in the single procedure case, the property checker maintains a forest F and an abstraction P_{≃} for every procedure P in the program. The interprocedural analysis differs from the intraprocedural algorithm described above only in the definition of the auxiliary function ExtendFrontier. The modified version of ExtendFrontier is shown in Table 8.

Informally, the interprocedural algorithm makes a recursive call to the PropertyChecker algorithm (see Table 3) at every frontier that corresponds to a function call in order to determine whether there exist tests that extend this frontier. If this is not possible, then the proof returned by the recursive PropertyChecker call is used to compute a suitable predicate.

TABLE 8
Pseudo-Code for Modified ExtendFrontier Function
(For Programs having Multiple Procedures)

ExtendFrontier(τ,F,P)
Returns:
{t,true}, if the frontier can be extended; or
{ε,ρ}, if the frontier cannot be extended.
1: τ_{w} = {S₀,S₁,...,Sₘ} := GetWholeAbstractTrace(τ,F)
2: (k − 1,k) := Frontier(τ_{w})
3: (φ₁,S,φ₂) := ExecuteSymbolic(τ_{w},F,P)
4: if Edge(Sₖ₋₁, Sₖ) ε CallReturn(E) then
5: let {Σ,σ^{I},→} = GetProc(Edge(Sₖ₋₁, Sₖ)) in
6: φ := InputConstraints( [symbol] )
7: φ′ := Sₖ[e/x]
8: {r,m} := PropertyChecker({Σ,σ^{I} [symbol] φ,→}, [symbol] φ′)
9: if r = “fail” then
10: t := m
11: else
12: φ₂ := GetInitPred(m)
13: t := ε
14: endif
15: else
16: t := IsSAT(φ₁,S,φ₂,P)
17: endif
18: if t = ε then
19: ρ := RefinePred(S,φ₂,τ_{w})
20: else
21: ρ := true
22: end if
23: return {t,ρ}

Specifically, the modified auxiliary function ExtendFrontier shown in Table 8 makes a call to PropertyChecker at frontiers that correspond to call-return edges (see line 8 of Table 8). This ExtendFrontier function first calls the auxiliary function GetWholeAbstractTrace (see line 1 of Table 8). GetWholeAbstractTrace takes an ordered abstract error trace τ={S₀,S₁, . . . ,Sₘ} and forest F as input, and returns an “expanded” whole abstract error trace τ_{w}. Essentially, τ_{w} is the abstract trace τ with all call-return edges up to its frontier replaced with the abstract trace traversed in the called function (and this works in a recursive manner). Then, if Edge(Sᵢ, Sᵢ₊₁) is a call-return edge that occurs before the frontier, the function GetWholeAbstractTrace runs a test t (obtained from the concrete witness in Sᵢ) on the called procedure GetProc(e) and replaces Edge(Sᵢ, Sᵢ₊₁) with the sequence of regions corresponding to the test case t.

The function ExecuteSymbolic (see line 3 of Table 8) performs symbolic execution on the whole abstract error trace τ_{w} as illustrated by the pseudo-code shown in Table 5. If the frontier corresponds to a call-return edge (see line 5 of Table 8) with a call to procedure Q={Σ, σ¹, →}, ExtendFrontier calls PropertyChecker on the property checking instance ({Σ, σ [symbol] φ, →}, [symbol] φ′). The predicate φ corresponds to the constraints on Q's input variables which are computed directly from the symbolic memory δ (by the auxiliary function InputConstraints shown at line 7 of Table 8), and φ′=Sₖ[e/x], where e is the returned expression in Q and x is the variable in the caller P that stores the return value.

Note that because both φ and φ′ may mention local variables with the same names as variables in the called function, either the identifiers in these predicates or the identifiers in the called function need to be varied appropriately at the point where PropertyChecker is called recursively. Note that this must be done in a manner that allows the AddTestToForest function to correctly match up concrete states with abstract states without mixing up different local variables having the same names. One example is to add a unique extension to each variable during testing to ensure that local variables having the same name in different procedures or functions will not be confused.

If PropertyChecker ({Σ, σ [symbol] φ, →}, [symbol] φ′) returns (“fail”, t), then the frontier can be extended by the test t; otherwise m corresponds to a proof that the frontier cannot be extended across the frontier. Computing a WP_{α} in this event would be expensive if the called function had several paths. However, the property checker can glean information from the way PropertyChecker split the initial region to get a suitable predicate that is more general than the path predicate φ. This predicate is computed by the auxiliary function GetinitPred (see line 13 of Table 8) which takes the proof m returned by PropertyChecker and returns a suitable predicate φ₂. The rest of the interprocedural algorithm is identical to that described above for the single procedure case.

4.0 Operational Summary of the Property Checker:

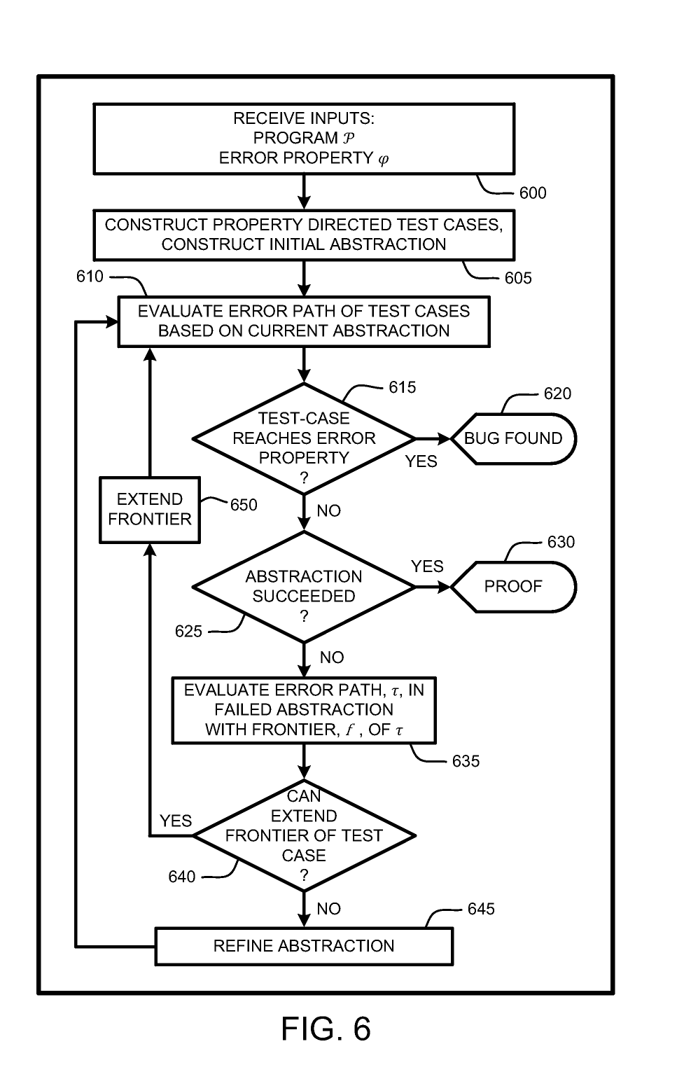

The processes described above with respect to FIG. 1 through FIG. 5 and in further view of the detailed description provided above in Sections 1 through 3 are illustrated by the general operational flow diagram of FIG. 6. In particular, FIG. 6 provides an exemplary operational flow diagram that illustrates operation of some of the various embodiments of the property checker described above. Note that FIG. 6 is not intended to be an exhaustive representation of all of the various embodiments of the property checker described herein, and that the embodiments represented in FIG. 6 are provided only for purposes of explanation.

Further, it should be noted that any boxes and interconnections between boxes that may be represented by broken or dashed lines in FIG. 6 represent optional or alternate embodiments of the property checker described herein, and that any or all of these optional or alternate embodiments, as described below, may be used in combination with other alternate embodiments that are described throughout this document.

In general, as illustrated by FIG. 6, the property checker begins operation by receiving inputs 600, including a program ρ, having one or more procedures, and an error property, φ, to be validated. The program checker first uses the program ρ, and the error property, φ, to construct 605 property directed test-cases and an initial abstraction of the program being validated with respect to the error property, φ.

Next, the property checker evaluates 610 the error path of the test cases using the current abstraction. This evaluation makes a determination 615 as to whether the test case reaches the error property given the current abstraction. If the test case does reach the error property, φ, then the property checker has found 620 an error or bug in the program, and the property checker will output the specific path that was used to reach the error property, φ.

If the evaluation 610 results in a determination 615 that the test case cannot reach the error property, φ, given the current abstraction, then the property checker examines the abstraction to determine 625 whether the current abstraction has succeeded in proving there is no possible path to error property, φ. If there is no possible path to the error property, φ, then this is a proof 630 that the program being tested is error free with respect to the particular error property, φ being evaluated.

However, if the property checker determines 625 that the current abstraction does not successfully prove that there is no path to the error property, φ, then the abstraction is considered a “failed abstraction.” The property checker will then evaluate 635 the error path, τ, of the failed abstraction in combination with the frontier, f, of the error path to determine 640 whether the frontier of the current test case can be extended.

If the property checker determines 640 that the frontier of the current test case can be extended, then the frontier is extended 650, and the processes described above, beginning with the evaluation 610 of the error path of the test case based on the current abstraction are repeated. Conversely, if the property checker determines 640 that the frontier of the current test case cannot be extended, then the property checker instead acts to refine 645 the abstraction. As with extension of the frontier 650, whenever the abstraction is refined 645, the processes described above, beginning with the evaluation 610 of the error path of the test case based on the current abstraction are repeated.

The above described steps then continue until such time as the property checker either identifies a bug 620 (i.e., a valid path to the error property, φ), or determines that the current abstraction proves that there is no possible path to the error property, φ.

5.0 Exemplary Operating Environments:

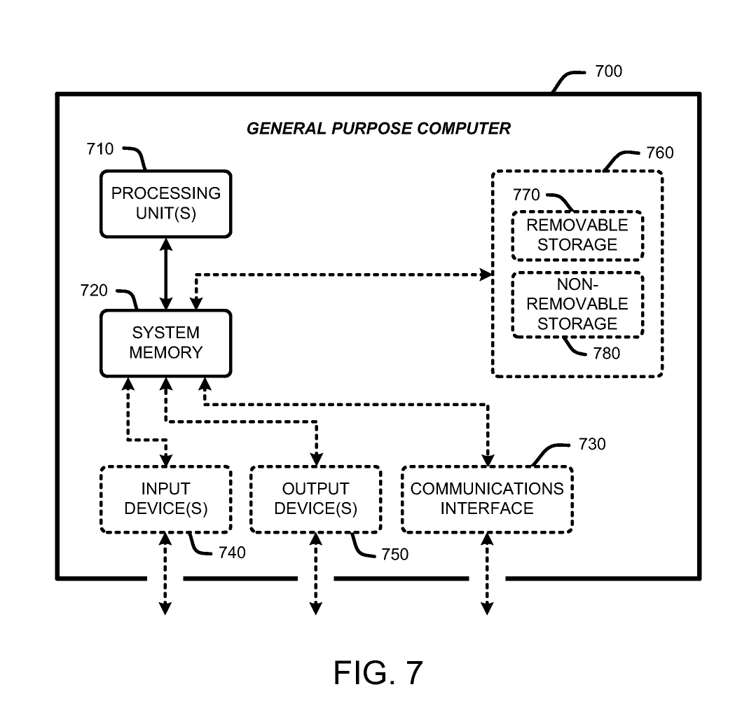

The property checker is operational within numerous types of general purpose or special purpose computing system environments or configurations. FIG. 7 illustrates a simplified example of a general-purpose computer system on which various embodiments and elements of the property checker, as described herein, may be implemented. It should be noted that any boxes that are represented by broken or dashed lines in FIG. 7 represent alternate embodiments of the simplified computing device, and that any or all of these alternate embodiments, as described below, may be used in combination with other alternate embodiments that are described throughout this document.

For example, FIG. 7 shows a general system diagram showing a simplified computing device. Such computing devices can be typically be found in devices having at least some minimum computational capability, including, but not limited to, personal computers, server computers, hand-held computing devices, laptop or mobile computers, communications devices such as cell phones and PDA's, multiprocessor systems, microprocessor-based systems, set top boxes, programmable consumer electronics, network PCs, minicomputers, mainframe computers, video media players, etc.

At a minimum, to allow a device to implement the property checker, the device must have some minimum computational capability along with some way to access the program data being validated. In particular, as illustrated by FIG. 7, the computational capability is generally illustrated by one or more processing unit(s) 710, and may also include one or more GPUs 715. Note that that the processing unit(s) 710 of the general computing device of may be specialized microprocessors, such as a DSP, a VLIW, or other micro-controller, or can be conventional CPUs having one or more processing cores, including specialized GPU-based cores in a multi-core CPU.

In addition, the simplified computing device of FIG. 7 may also include other components, such as, for example, a communications interface 730. The simplified computing device of FIG. 7 may also include one or more conventional computer input devices 740. The simplified computing device of FIG. 7 may also include other optional components, such as, for example one or more conventional computer output devices 750. Finally, the simplified computing device of FIG. 7 may also include storage 760 that is either removable 770 and/or non-removable 780. Note that typical communications interfaces 730, input devices 740, output devices 750, and storage devices 760 for general-purpose computers are well known to those skilled in the art, and will not be described in detail herein.

The foregoing description of the property checker has been presented for the purposes of illustration and description. It is not intended to be exhaustive or to limit the claimed subject matter to the precise form disclosed. Many modifications and variations are possible in light of the above teaching. Further, it should be noted that any or all of the aforementioned alternate embodiments may be used in any combination desired to form additional hybrid embodiments of the property checker. It is intended that the scope of the invention be limited not by this detailed description, but rather by the claims appended hereto.

What is claimed is:

1. A method for determining correctness of a software program with respect to a safety/correctness property, comprising steps for:
(a) receiving a software program;
(b) receiving the safety/correctness property to be validated;
(c) constructing an abstraction of the software program;
(d) generating a property directed test case;
(e) evaluating the current test case to determine whether an error path of the current abstraction violates the safety/correctness property;
(f) if the error path violates the safety/correctness property, outputting the current abstraction and error path as an identification of an error in the software program; and
(g) if the error path does not violate the safety/correctness property, determining whether the current abstraction successfully proves the correctness of the software program with respect to the safety/correctness property.

2. The method of claim 1 wherein if the current abstraction fails to successfully prove the correctness of the software program:
(h) extending a frontier representing a farthest extent of the path to create a new current test case, if possible;
(i) if the frontier cannot be extended, refining the abstraction;
(j) repeating steps (e), (f) and (g) after performing steps (h) and (i) until any of identifying an error in the software program and proving the correctness of the software program with respect to the error property.

3. The method of claim 2 further comprising steps for generating a “WP_{α} operator” by combining a weakest precondition operator with an alias set obtained while evaluating the current test case.

4. The method of claim 3 wherein refining the abstraction includes steps for using the WP_{α} operator such that the new current abstraction will only include alias conditions that will actually occur during execution of the software program.

5. The method of claim 2 wherein refining the abstraction comprises splitting at least one region of the abstraction into two regions and constructing one or more new error paths by adding edges for connecting possible paths to create a new current abstraction.

6. The method of claim 1 wherein the software program is received as an x86 program binary.

7. The method of claim 2 further comprising steps for determining correctness of software programs having multiple procedures without using any whole-program may-alias analysis by performing an inter-procedural analysis which includes recursive invocations of steps (a) through (j) to address each separate procedure in the software program.

8. A system for determining whether a required property of a software program is satisfied, comprising:
a device for receiving a software program and identifying the required property;
a device for constructing an abstraction of the software program;
a device for generating a property directed test case;
a device for evaluating the current test case to determine whether an error path of the current abstraction violates the required property;
a device for outputting information identifying an error in the software program corresponding to the required property in the event that the error path of the current abstraction violates the required property; and
a device for determining whether the current abstraction proves the correctness of the required property in the event that the error path of the current abstraction does not violate the required property.

9. The system of claim 8 further comprising a device for extending a frontier representing a farthest extent of the error path to create a new current test case, if possible, in the event that the current abstraction fails to successfully prove the correctness of the software program.

10. The system of claim 9 further comprising a device for refining the current abstraction in the event that it is not possible to extend the frontier.

11. The system of claim 10 further comprising reusing the device for evaluating the current test case to determine whether the error path of the current abstraction violates the required property.

12. The system of claim 10 further comprising a device for generating a “WP_{α} operator” by combining a weakest precondition operator with an alias set obtained while evaluating the current test case.

13. The system of claim 12 wherein the device for refining the current abstraction uses the WP_{α} operator to ensure that the new current abstraction will only include alias conditions that will actually occur during execution of the software program.

14. The system of claim 8 further comprising a device for determining correctness of software programs having multiple procedures by performing an inter-procedural analysis that includes recursive invocations of all devices identified in claim 8 to address each separate procedure in the software program.

15. A computer-readable medium having computer executable instructions stored therein for determining whether a required property of a computer program is correct, said instructions comprising:
specifying required property to be evaluated for a software program;
constructing an abstraction of the software program;
generating a property directed test case for use with the abstraction;
evaluating the current test case to determine whether an error path of the current abstraction violates the required property;
in the event that the error path violates the required property, outputting the current abstraction and error path as an identification of an error in the software program; and
in the event that the error path does not violate the required property, determining whether the current abstraction successfully proves the correctness of the software program with respect to the required property.

16. The computer-readable medium of claim 15 further comprising extending a frontier representing a farthest extent of the path to create a new current test case, if possible, in the event that the current abstraction fails to successfully prove the correctness of the software program.

17. The computer-readable medium of claim 16 further comprising refining the abstraction in the event that the frontier cannot be extended.

18. The computer-readable medium of claim 17 further comprising:
evaluating the current test case to determine whether an error path of the current abstraction violates the required property;
in the event that the error path violates the required property, outputting the current abstraction and error path as an identification of an error in the software program; and
in the event that the error path does not violate the required property, determining whether the current abstraction successfully proves the correctness of the software program with respect to the required property.

19. The computer-readable medium of claim 17 further comprising steps for generating a “WP_{α} operator” by combining a weakest precondition operator with an alias set obtained while evaluating the current test case.

20. The computer-readable medium of claim 19 wherein refining the abstraction includes using the WP_{α} operator such that the new current abstraction will only include alias conditions that will actually occur during execution of the software program.
